(19) United States
(12) Patent Application Publication
(10) Pub. No.: US 2009/0083716 A1
(43) Pub. Date: Mar. 26, 2009

(54) PROFILING METHOD AND PROGRAM

(75) Inventor: Shigeru KIMURA, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU MICROELECTRONICS LIMITED, Tokyo (JP)

(21) Appl. No.: 12/210,552

(22) Filed: Sep. 15, 2008

(30) Foreign Application Priority Data
Sep. 20, 2007 (JP) 2007-243478

(51) Int. Cl. G06F 9/44

(52) U.S. Cl. 717/129

(57) ABSTRACT

A profiling method for collecting, using a computer, information on an execution status of a target program. Information collection is performed for the target program using an interrupt handler that is initiated in response to an interrupt that occurs when a predetermined condition is satisfied. The profiling method includes specifying a target range in which information collection is to be performed using the interrupt handler, in the target program,; and setting information collected by the interrupt handler in a memory when the interrupt occurs in the target range.

### CROSS-REFERENCE TO RELATED APPLICATIONS

This application is based upon and claims the benefit of priority from the prior Japanese Patent Application No. 2007-243478 filed on Sep. 20, 2007, the entire contents of which are incorporated herein by reference.

### BACKGROUND OF THE INVENTION

1. Field

The embodiments relates to a profiling method for collecting information on the execution status of a program and to a program for use therewith.

2. Description of the Related Art

Profiling techniques are widely used in computer systems for performing performance analysis, optimization or the like. Profiling is effective for analyzing the time distribution, the running frequency, and the calling frequency of target program code inside a program, and the like. The following two techniques are available for causing a program to be operated by an operating machine in order to perform profiling.

Japanese Patent Laid-Open Nos. 11-212838 and 2003-140928 disclose a first technique in which profiling code is inserted into a compiler and execution information is collected. The first technique is the most commonly used profiling technique and is installed in compiler products as a standard function.

In “OProfile—A System Profiler for Linux” and “Intel VTune performance analyzer”, which are disclosed on the Internet, profiling based on sampling using a hardware timer or a performance monitoring mechanism of a CPU is described as a second technique.

In the second technique, an interrupt of a sampling or a hardware event is caused to occur at a fixed time period, or each time a hardware counter for the number of execution instructions that can be measured by a processor or a peripheral circuit or for the number of cache misses reaches a fixed number of times. A profiling program registered as an interrupt process records an execution instruction address or the like when an interrupt occurs. As a result of the above, a code range in which, statistically, the most time is consumed, a code range in which code has been most frequently executed, a code range in which hardware events have occurred most frequently, and other code ranges are extracted.

Japanese Patent Laid-Open No. 7-191882 discloses a technique of tracing an instruction by using an instruction level simulator. However, if a high access cost, that is, the number of execution cycles, is to be simulated by using a simulator, there is a problem that performing a simulation using the simulator takes some time since an instruction is traced on a per command basis. Furthermore, simulators have a problem in that they are incapable of obtaining completely accurate information due to existence of problems unique to an actual machine environment, such as access latency delay.

### SUMMARY

According to an aspect of an embodiment, there is provided a profiling method for collecting, using a computer, information on an execution status of a target program for which information collection is performed using an interrupt handler that is initiated in response to an interrupt that occurs when a predetermined condition is satisfied, the profiling method including: specifying a target range in which information collection is to be performed using the interrupt handler in the target program; and setting information collected by the interrupt handler in a memory when the interrupt occurs in the target range.

The above-described embodiments of the present invention are intended as examples, and all embodiments of the present invention are not limited to including the features described above.

### BRIEF DESCRIPTION OF THE DRAWINGS

FIG. 1 shows the configuration of an electronic apparatus to which the present embodiment can be applied;

FIG. 2 shows an example of an event management table;

FIG. 3 shows an example of an interrupt handler recording table;

FIG. 4 is a flowchart illustrating processing procedures of an embodiment;

FIG. 5 illustrates specification of a target range at linking time;

FIG. 6 illustrates a method of specifying the target range of profiling and an area in which sampling values are stored in a memory;

FIG. 7 is a flowchart illustrating processing when a timer interrupt occurs;

FIG. 8 is a flowchart illustrating processing of an analysis processor;

FIG. 9 shows an example of display of profiling results;

FIG. 10 is a block diagram showing computer hardware and an analysis processor; and

FIG. 11 is a flowchart illustrating processing for automatically extracting the target range of profiling.

### DETAILED DESCRIPTION OF THE PREFERRED EMBODIMENTS

Examples of a profiling method and a program will be described below with reference to the drawings.

### Embodiment

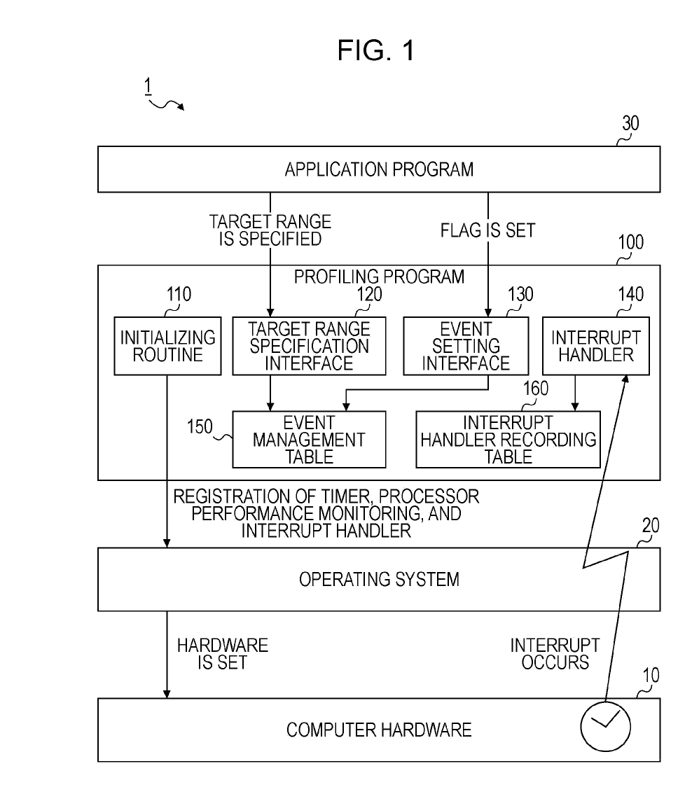

First, the configuration of an electronic apparatus to which the present embodiment is applied will be described with reference to FIGS. 1 to 3.

FIG. 1 shows the configuration of an electronic apparatus of the present embodiment. As shown in FIG. 1, an electronic apparatus 1 has a configuration in which computer hardware (or a processor) 10, an operating system 20, an application program (execute form file) 30, and a profiling program 100 collect information in cooperation with one another. Even in an environment in which there is no operating system, the present embodiment can be realized by providing an alternative mechanism for the operating system. For this reason, in the following description, an example is described in which there is an operating system 20. For the basic configuration of the electronic apparatus 1, a basic configuration similar to that of a well-known general-purpose computer system can be adopted.

The computer hardware 10 is an apparatus that executes a program in accordance with an included profiling program 100. When an event specified by the operating system 20 occurs, the computer hardware 10 generates an interrupt and executes a pre-registered interrupt processing program. The computer hardware 10 includes a processor core formed of a processor such as a CPU, a hardware counter, a built-in timer, and a storage unit such as a cache memory.

The operating system 20 is a control program that manages the resources of the computer hardware 10 and that performs execution control of the application program 30, and the like, and sets an interrupt generation event in the computer hardware 10.

The application program 30 is a program for which information is collected (or tuning is performed). The application program 30 performs a process necessary to collect information by calling a library function (or a profiling start function). The application program 30 calls the library function by using an API provided by the profiling program 100. In the present embodiment, the profiling program 100 including an interrupt handler 140 and a code range marking symbol source or object is coordinated (that is, linked) with the application program 30. At this time, only the program and function desired to be profiled are extracted as desired and specified as a target range (or a measurement range). The target range is specified by sandwiching a target code part with a code range marking symbol. In profiling, a memory of the same size as the target code part is necessary inside the computer hardware 10. For this reason, by specifying the target range in this manner, even if the electronic apparatus 1 is an embedded apparatus having large memory constraints, such as memory resources being scarce, profiling in which the target range is narrowed is possible.

In the following description, a case is used as an example in which an area inside the memory in which profiling values are stored has the same size as the code size. The size of the area for storing profiling values is the same as the code size of one instruction. However, the present embodiment is not limited to such a case. That is, an area for storing profiling values corresponding to individual instructions needs only be provided regardless of the length of the instruction.

The profiling program 100 is a program for collecting information on the application program 30. The profiling program 100 has an initialization routine 110, a target range specification interface 120, an event setting interface 130, an interrupt handler 140, an event management table 150, and an interrupt handler recording table 160. The program of the present embodiment corresponds to the profiling program 100. The profiling method of the present embodiment is performed by a computer that executes the profiling program 100.

The initialization routine 110 requests the operating system 20 to set a timer for generating a sampling interrupt and to register the interrupt handler 140. The interrupt handler 140 is initiated when a sampling interrupt occurs. Events such as execution of commands of a fixed number of times, accesses to a specific address of a fixed number of times, and events in which a processor performance monitoring mechanism generates an interrupt, such as occurrence of a cache miss, can be set as sampling interrupt generation events, in addition to an elapse of a fixed time period using a timer.

The target range specification interface 120 is performed by a start specification API in which the application program 30 specifies a starting of the measurement. When a function name or a label attached to execution code is specified as the target range of information collection, the target range specification interface 120 operates in the following manner. The target range specification interface 120 obtains the start address and the end address of the target function (or function containing a label) from the operating system 20 and the application program 30 including a start-up routine, and registers them in the event management table 150.

In the present embodiment, as described above, a profiling program including the interrupt handler 140, and a code range marking symbol source or object are linked with the application program 30. Therefore, the target range can also be specified by extracting and specifying as desired only the program and the function desired to be profiled. Profiling in which the target range is narrowed is possible even if the electronic apparatus 1 is an embedded apparatus in which memory constraints are stringent.

The event setting interface 130 is a library function that receives an argument regarding an event value from the application program 30. The event setting interface 130 also sets an event value for the target range of information collection, and provides an API used by the application program 30 in order to specify an event value.

At this point, an event is an attribute (variable) associated with a value collected by the interrupt handler 140 when the interrupt handler 140 is initiated within the target range of information collection. A plurality of values can be set for the event value. This event setting interface 130 receives an event value as an argument regarding the event value from the application program 30. Then, the event setting interface 130 sets an event value for the target range of information collection, making it possible to collect various items of information on the execution status of the application program 30. For example, when interrupts are made to occur at fixed time intervals, as an attribute of the event, an interrupt interval is specified. The interrupt interval is specified as a parameter for the start specification API from the application program 30.

The interrupt handler 140 is initiated in response to a sampling interrupt by a timer or in response to a sampling interrupt by the processor performance monitoring mechanism. The interrupt handler 140 is an interrupt processing program for recording an execution address when an interrupt occurs in the interrupt handler recording table 160. When the interrupt handler 140 is initiated within the target range of information collection, which is registered in the event management table 150, the interrupt handler 140 records an event value corresponding to the execution address when the interrupt occurs in the interrupt handler recording table 160. For example, when an interrupt is made to occur at a fixed time, in an area corresponding to a program counter for occurrence of interrupts, the number of times interrupts have occurred is stored in the interrupt recording table 160.

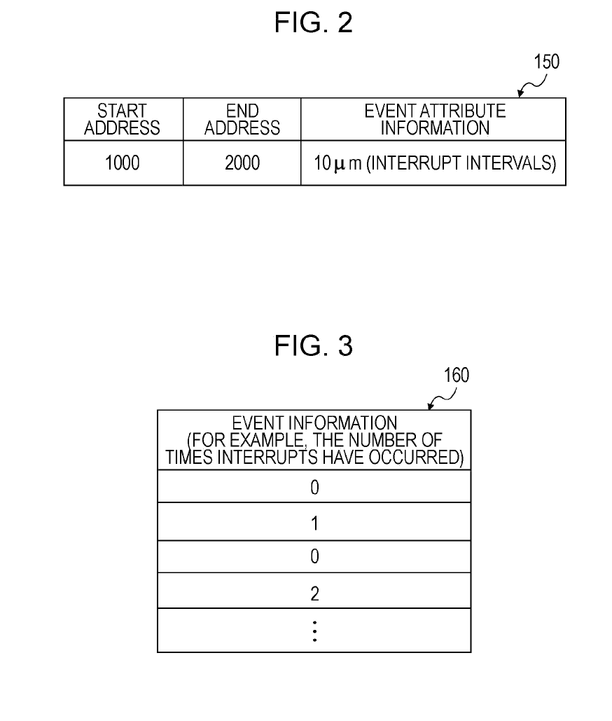

The event management table 150 stores information on the information collection of the application program 30. FIG. 2 shows an example of the event management table 150. As shown in FIG. 2, the event management table 150 stores the start address of the target range, the end address of the target range, and event values in such a manner as to be associated with one another for each target range of information collection of the application program 30.

When the start address of the target range of information collection is “1000”, the end address thereof is “2000”, and the interrupt handler 140 is initiated in the target range, the interrupt handler 140 allows the number of interrupts as events to be collected as information.

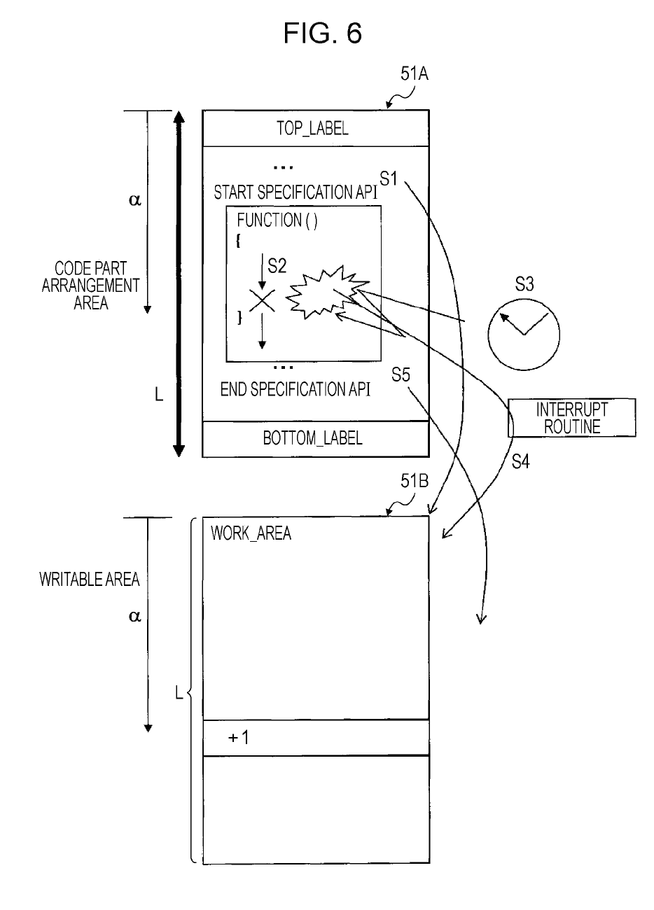

Information collected by the interrupt handler 140 when the interrupt handler 140 is initiated in response to a sampling interrupt is recorded in the interrupt handler recording table 160. FIG. 3 shows an example of the interrupt handler recording table 160. An event value (for example, the number of interrupts) is recorded in the interrupt handler recording table 160 when a sampling interrupt occurs. This event value is associated with the execution address at interrupt time. The execution address at interrupt time is the execution address of the application program 30 when the execution address at interrupt time is within the target range of information collection. The detailed method for collecting the information is stored by the method indicated by 51B in FIG. 6.

For example, if the execution address of the application program 30 when a sampling interrupt occurs is “1200”, in the case that the target range of information collection, shown in FIG. 2, and the execution address is in the measurement range of the event management table 150, the execution address at interrupt time is in the target range of information collection. As a result, a value that is incremented by “+1” is recorded as an event value (the number of interrupts) associated with the execution address “1200”.

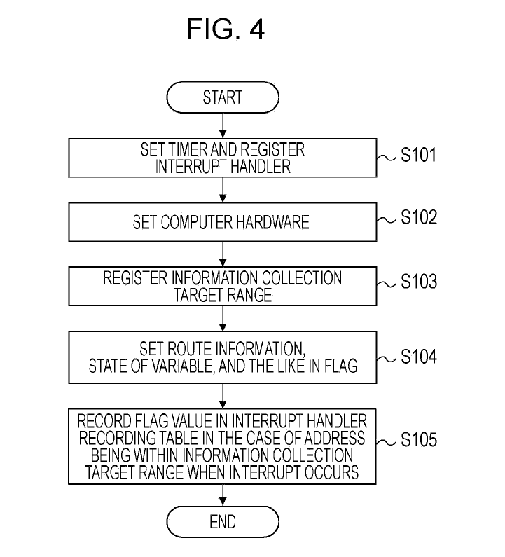

Next, the processing procedure of the present embodiment will be described with reference to FIG. 4. FIG. 4 is a flowchart illustrating the processing procedure of the present embodiment. In this profiling system, in operation S101, an initialization routine 110 (shown in FIG. 1) of the profiling program 100 requests the operating system 20 (shown in FIG. 1) to perform setting regarding a sampling interrupt generation event, such as setting of a timer. Furthermore, the initialization routine 110 requests the operating system 20 to register the interrupt handler 140 (shown in FIG. 1). In an environment in which there is no operating system, instead, the interrupt handler 140 is registered.

In operation S102, the operating system 20 performs setting necessary to cause a sampling interrupt to occur, such as setting of a timer, in the computer hardware 1 0 (shown in FIG. 1). In an environment in which there is no operating system, instead, the computer hardware 10 is set. As a result, sampling interrupts occur at fixed time intervals or for every fixed number of processor events, and the interrupt handler 140 is called.

In operation S103, when the application program 30 (shown in FIG. 1) calls the target range specification interface 120 (shown in FIG. 1) embedded by the user, the target range specification interface 120 registers information on the target range of information collection in the event management table 150.

In operation S104, when the application program 30 calls the event setting interface 130 in order to set path information, the status of a variable, and the like in an event by the user, the event setting interface 130 records event values in the event management table 150 (shown in FIG. 1). The user specifies the range of information collection for the event value target.

In operation S105, when the interrupt handler 140 is initiated in response to a timer interrupt or the like, the interrupt handler 140 records the execution address at interrupt time in the interrupt handler recording table 160 (shown in FIG. 3), and records a corresponding event value if the address is in the target range of information collection.

As described above, the event setting interface 130 records the event value in the event management table 150, and the interrupt handler 140 records the event value in the interrupt handler recording table 160 if the execution address at interrupt time is in the target range of information collection. As a result, it is possible to collect path information and detailed information, such as the status of a variable, which are set in the event values. The data in the event management table 150 and the interrupt handler recording table 160 is stored in the memory inside the computer hardware 10.

The data including sampling values stored in the memory is received by a debugger of an analysis processor (not shown), which is an external device that can be connected to the electronic apparatus 1 (shown in FIG. 1). A program that checks the data in which sampling values are stored against the symbol information of the application program 30 allows sampling values to be displayed on the display unit of the analysis processor for each high cost function, for each high cost process, and for each high cost instruction. This makes it possible to specify a bottleneck location in the application program 30.

Next, a description will be given in more detail of a method of specifying the target range of profiling and of an area where sampling values are stored in a memory.

As described above, in the present embodiment, in profiling, the count value of the corresponding address rather than the sampled address is set. Furthermore, when the profiling program 100 is to be linked with the application program 30, the specified code range marking symbol is set. The symbol name of the code range marking symbol is any desired one. For example, TOP₁₃ LABEL and BOTTOM₁₃ LABEL are set as addresses of the start position and the end position of the code part arrangement area. The source or the target, in which TOP₁₃ LABEL and BOTTOM₁₃ LABEL are defined, is joined at the time of linking with the profiling program 100 of the application program 30 for which information is to be collected.

A portion of the application program 30 for which information is desired to be collected is output to the section in units of modules or functions, and is automatically output by a compiler, or the user explicitly divides the section. All the code part can be set in one target range.

The specification (link command character string) of the target range at linking time is, for example, as described below.

(a)-sc TOP₁₃ LABEL, */code, BOTTOM₁₃ LABEL, . . . , *, WORK_AREA(b)-sc TOP₁₃ LABEL=0x00000100, BOTTOM₁₃ LABEL=0x00001100, WORK_AREA=0x01000000

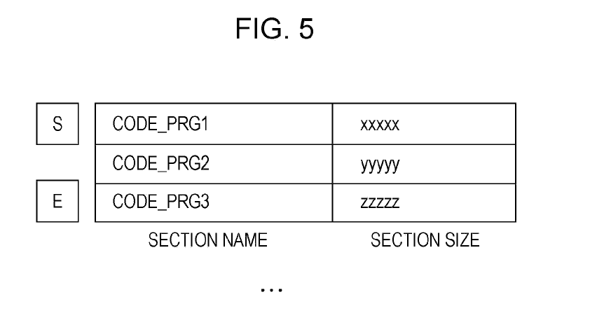

The specification (GUI specification method) of the target range at linking time is, for example, as shown in FIG. 5. FIG. 5 shows a case in which TOP_LABEL(S) and BOTTOM₁₃ LABEL(E) are specified from the list in which section names are displayed.

In the above-described method, the user sets the application program 30 for which information is collected at linking time. It is necessary for the user to ascertain the size of the area in which the number of sampling interrupts is stored and the application program 30 for which tuning is to be performed. The area in which the number of sampling interrupts is stored is used by the application program 30. Usually, the program for which tuning should be performed has been identified, and even in an unknown case, the tuning targets can be narrowed down by sequentially narrowing the target range.

As described above, the application program 30 linked with the profiling program 100 is executed in the installed environment of the electronic apparatus 1. In the interrupt handler 140 of the profiling program 100, the values of a program counter and a hardware counter indicating the processor status are stored in the memory for each interrupt of the built-in timer. The relationship between the interrupt process, the sampling value storage method, and the area of the memory in which sampling values are stored is, for example, as shown in FIG. 6. FIG. 6 illustrates a method for specifying the target range of profiling, and an area of a memory in which sampling values are stored at linking time. In FIG. 6, reference numeral 51A denotes a code part arrangement area inside the memory of the computer hardware 10. Reference numeral 51B denotes a writable area (that is, a work area) inside the memory of the computer hardware 10.

In operation S1, the timer for causing a sampling interrupt to occur is initiated. In operation S2, the number-of-interrupts counting area is zero-cleared in an amount equal to the size L of the target range. Here, L is determined on the basis of the difference between symbol addresses, as shown in the following equation.

L=(address of BOTTOM_LABEL)−(address of TOP₁₃ LABEL)

In operation S3, the timer that is initiated causes an interrupt to occur at fixed intervals. The interrupt intervals are specified by a start specification API. In operation S4, a relative address a is determined from the address of the start position TOP₁₃ LABEL of the code part arrangement area 51A. Data such that the number-of-interrupts data is incremented by “+1” from the beginning of the writable area 51B is stored at the position corresponding to the relative address α. In operation S5, the processing of the timer is completed, and the number-of-interrupts data in the memory is received by the debugger and the like.

The present embodiment can also be applied to a processor having a hardware counter for monitoring processor performance by counting the occurrence of events inside the processor or the occurrence of events of exchange with outside the processor. In this case, an interrupt that occurs at fixed time intervals may be used as a trigger for information collection. The status of the hardware counter when any event occurs may also be used as a trigger. More specifically, a case in which information is obtained by using the number of execution cycles of the processor as an indicator is replaced with a data cache miss occurrence event of the hardware counter. In this case, it is possible to analyze the instruction of the cache miss and to analyze the access destination since an interrupt is caused to occur in response to the instruction in which a cache miss occurred. In the manner described above, a hardware event of the hardware counter, which occurs at fixed time intervals, may be used as a trigger.

An occurrence of a hardware event can be detected by providing an event counter for obtaining hardware information on the processor on the processor side. The hardware information on the processor includes the number of cache misses, the number of translation lookaside buffer (TLB) misses, the number of execution instructions, the degree of parallelness of execution instructions, the number of branch instructions, pipeline stalled factors, the register interference cycles, bus access information, and the like.

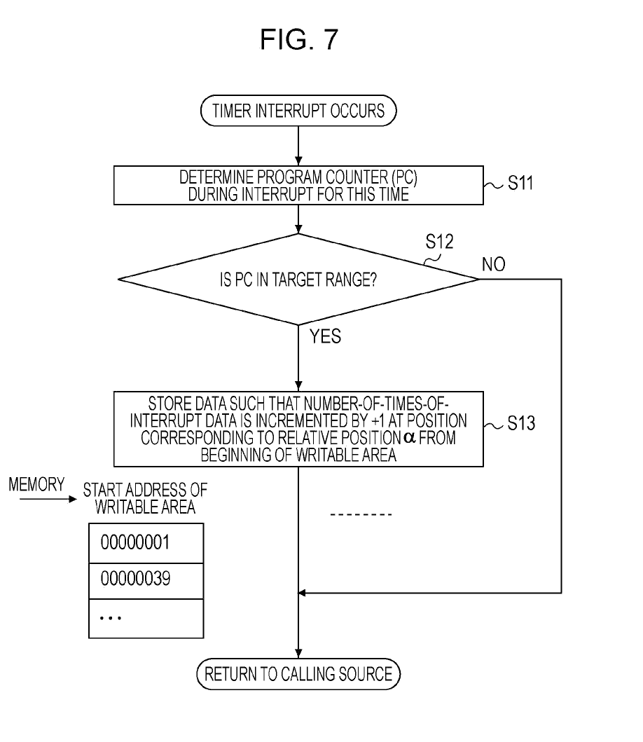

FIG. 7 is a flowchart illustrating processing performed when a timer interrupt occurs. In FIG. 7, when a timer interrupt occurs, in operation S11, the value of the program counter (PC) at the time of timer interrupt for this time is determined. In operation S1 2, it is determined whether or not the value of the program counter is within the target range, that is, (the start position TOP₁₃ LABEL)<PC<(the end position BOTTOM₁₃ LABEL) is satisfied. The relative address a from the address of the start position TOP₁₃ LABEL is determined in operation S13 if the determination result in operation S12 is YES. Data such that the number-of-interrupts data is incremented by “+1” from the beginning of the writable area is stored at the position corresponding to the relative address α. The process then returns to the calling source.

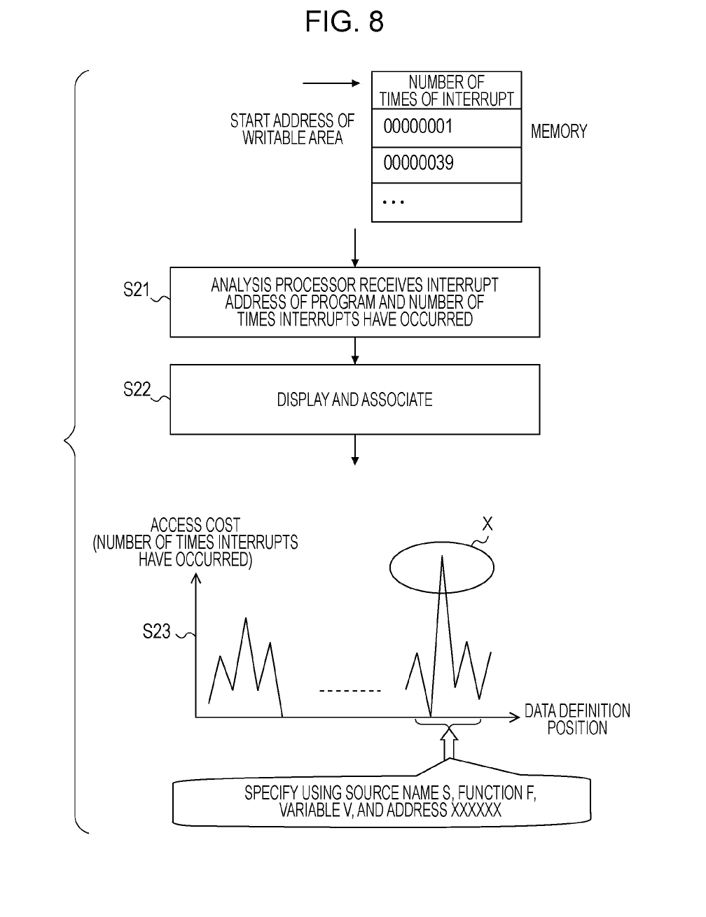

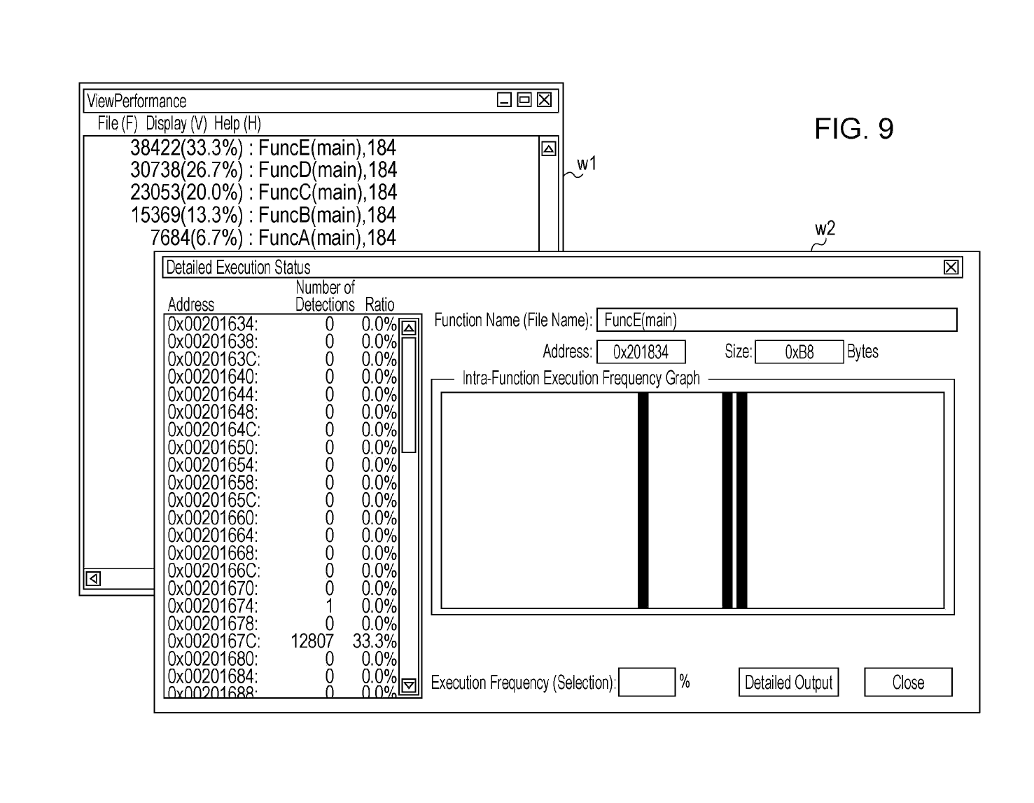

FIG. 8 is a flowchart illustrating the processing of an analysis processor. In FIG. 8, the interrupt address and the number of interrupts of the application program 30 are received from a memory inside the electronic apparatus 1 when the analysis processor (not shown) is connected to the electronic apparatus 1 and an analysis process is started. In operation S22, the program definition, the number of interrupts, and the like, which are stored in the memory inside the electronic apparatus 1, are read, and the program position and the number of times interrupts have occurred are displayed in the form of a graph or the like on the display unit of the analysis processor. The program position is displayed in such a manner as to be identified with the function name of the corresponding source program. The symbol information, the debugger information, and the like of the program file can be used for associating the program position with the function name of the source program. In this manner, for example, results of profiling as shown in FIG. 9 are displayed.

FIG. 9 shows an example of display of the results of profiling. In FIG. 9, values such as “38422” in a window W1 indicate a number of times interrupts have occurred, “FuncE” indicates a function, and “184” indicates the size of the memory area. For example, by double-clicking a function in the window W1, the process shifts to a corresponding C source or assembler source window W2 the number of times interrupts have been detected corresponding to the address and the execution frequency (that is, the execution status) of the information collection target program in the function FuncE is displayed in the assembler source window W2. In the case of the example of display shown in FIG. 9, interrupts are displayed for functions in descending order of frequency. The access cost, that is, the number of interrupts, is displayed in units of assembler instructions in the function. By identifying the corresponding function and instruction position with a click or the like, it is possible to shift to a corresponding C source or assembler source window (debugger, editor, tool, or the like).

The description now returns to FIG. 8. In operation S23, the access cost, that is, the number of interrupts, is displayed with respect to the data definition position, for example, in graph form as shown in FIG. 8. The data definition position can be set using a source name S, a function name F, a variable V, an address A, and the like. In this case, it can be seen that the access cost is high in the vicinity of an address indicated by XXXXXX.

In this manner, the sampling value collected by the interrupt handler 140 and any hardware event information can be set as the number of times execution has been performed in an area associated with an individual instruction. By identifying the collected sampling value with the execution form program by using the interrupt handler 140, it is possible to compare functions, processes, and instructions having a high execution frequency with one another and to identify the functions, processes, and instructions with a corresponding C source or machine word instruction and display the functions, processes, and instructions. Furthermore, the sampling value collected by the interrupt handler 140 and any hardware event information are merged, and values merged each time these items of information are obtained are held as experience values in the memory, thereby making it possible to improve the accuracy of the profiling.

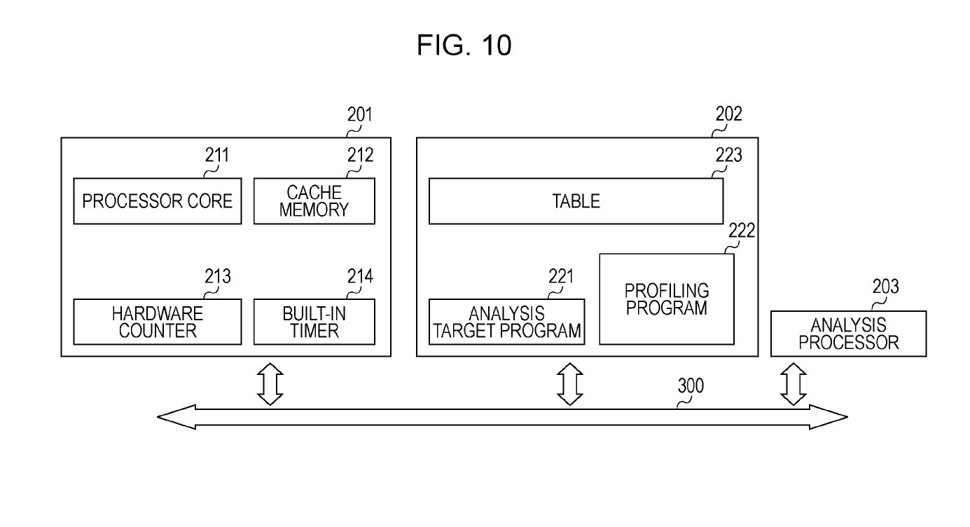

FIG. 10 is a block diagram showing computer hardware and an analysis processor.

FIG. 10 shows a state in which a measurement processor 201 corresponds to the computer hardware 10 shown in FIG. 1. The measurement processor 201 includes a processor core 211 for processing various kinds of instructions, a cache memory 212 for holding data, a hardware counter 213, and a built-in timer 214 for outputting an interrupt signal at fixed intervals. The hardware counter 213 monitors performance by counting the occurrence of events inside the measurement processor 201 and/or the occurrence of exchanges with components outside the measurement processor 201. The cache memory 212 may be externally connected to the measurement processor 201.

The storage unit 202 holds an analysis target program 221, a profiling program 222, and a table 223 in which the number of times interrupts have occurred based on a detection instruction address or the count value of the hardware counter 213 is stored. The analysis target program 221 is software for which profiling is performed, and corresponds to the application program 30 shown in FIG. 1. The profiling program 222 is software for obtaining profile information on the analysis target program 221, and corresponds to the profiling program 100 shown in FIG. 1. The measurement processor 201, the storage unit 202, and the performance analysis processor 203 are interconnected with one another through a bus 300.

The timer 214 outputs an interrupt signal at predetermined time intervals after the analysis target program 221 is started to be executed. The predetermined time intervals of this interrupt signal can be set by the profiling program 222. An instruction address at which an occurrence of an interrupt is detected or an instruction address at which an occurrence of an interrupt of the hardware counter 213 is detected is stored in the table 223. An occurrence of an interrupt is detected by using as a trigger an occurrence of an event of the hardware counter 213. The hardware counter 213 starts counting at the same time as when the execution of the analysis target program 221 is started similarly to the timer 214. The table 223 is created while the performance of the analysis target program 221 is being analyzed. The analysis processor 203 is a processor for displaying execution results in the measurement processor 201. The analysis processor 203 is formed separately from the measurement processor 201. The analysis processor 203 reads the information held in the table 223 and displays it in such a manner as to be associated with a source name, a function, a variable name, and an intra-variable relative address, as shown in FIGS. 8 and 9.

Furthermore, the application program 30 (analysis target program 221) for which information collection is performed may be automatically narrowed. In this case, the application program 30 for which information collection is performed may be extracted as a profile target candidate from a program having a large execution cost on the basis of the profile information obtained by the simulator. Furthermore, source code for the profile target may be extracted according to the degree of complexness of a function and according to the magnitude of static analysis information, such as a calling relationship among functions.

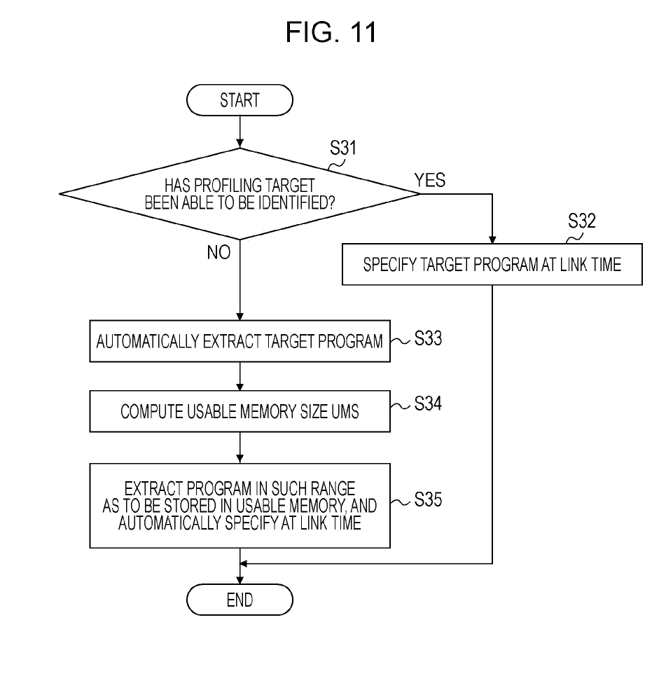

FIG. 11 is a flowchart illustrating processing for automatically extracting the target range of profiling. In FIG. 11, in operation S31, it is determined whether or not the user has identified a target of profiling. When the determination result in operation S31 is YES, in operation S32, the user specifies the application program 30 for which profiling is performed when it is to be linked with the profiling program 100, and the processing is then completed.

On the other hand, when the determination result in operation S31 is NO, in operation S33, a process in which the computer hardware 10 (that is, the processor) automatically extracts the application program 30 for which profiling is performed is started. In operation S34, the usable memory size UMS within the memory of the computer hardware 10 is computed. In operation S35, the target range of the application program 30 is extracted in such a range as to fall within the memory size UMS that can be used by the computer hardware 10. Furthermore, in operation S35, the target range is automatically specified when the application program 30 for which profiling is performed is to be linked with the profiling program 100.

In operation S35, a first method is used in which the application program 30 for which profiling is performed is extracted as a profiling target candidate from a program having a large execution cost on the basis of profile information obtained by the simulator. Alternatively, in operation S35, a second method may be used in which source code for a profiling target candidate is extracted according to the degree of complexness of a function or according to the magnitude of static analysis information, such as a calling function among functions.

The turn of the embodiments isn't a showing the superiority and inferiority of the invention. Although the embodiments of the present inventions have been described in detail, it should be understood that the various changes, substitutions, and alterations could be made hereto without departing from the spirit and scope of the invention.

Although a few preferred embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A profiling method for collecting, using a computer, information on an execution status of a target program for which information collection is performed using an interrupt handler that is initiated in response to an interrupt that occurs when a predetermined condition is satisfied, the profiling method comprising:
specifying a target range in which information collection is to be performed using the interrupt handler in the target program; and
setting information collected by the interrupt handler in a memory when the interrupt occurs in the target range.

2. The profiling method according to claim 1, wherein, the target range is specified when a profiling program including the interrupt handler and a code range marking symbol source or object are to be linked with the target program.

3. The profiling method according to claim 1, wherein the interrupt occurs on the basis of a count value of a hardware counter that counts the occurrence of events inside the computer or the occurrence of an exchange with a component outside the computer.

4. The profiling method according to claim 1, further comprising setting the area being associated with an individual instruction in an area of the memory, and
setting a sampling value and hardware event information included in the information collected by the interrupt handler as the number of times execution has been performed or the number of events that have occurred in the area of the memory.

5. The profiling method according to claim 1, further comprising:
identifying a sampling value included in the information collected by the interrupt handler with an execution form program,
comparing functions, processes, and instructions having a high execution frequency with one another,
identifying the functions, the processes, and the instructions with a corresponding C source or machine word instruction, and
displaying the functions, the processes, and the instructions on a display unit of an analysis processor connected to the computer.

6. The profiling method according to claim 1, further comprising:
merging a sampling value and hardware event information included in the information collected by the interrupt handler, and
storing the merged result as an experience value in the memory.

7. A computer-readable recording medium that stores therein a computer program for making a computer execute profiling for collecting information on an execution status of a target program for which information collection is performed using an interrupt handler that is initiated in response to an interrupt that occurs when a predetermined condition is satisfied, the computer program making the computer execute:
specifying a target range in which information collection is performed using the interrupt handler in the target program; and
setting information collected by the interrupt handler in a memory when the interrupt occurs in the target range.

8. The computer-readable recording medium according to claim 7, wherein the computer program further makes the computer execute specifying the target range in the target program when a profiling program including the interrupt handler is to be linked with a code range marking symbol source or object.

9. The computer-readable medium according to claim 7, wherein the interrupt occurs on the basis of a count value of a hardware counter for counting the occurrence of events inside the computer or the occurrence of an exchange with a component outside the computer.

10. The computer-readable medium according to claim 7, wherein the computer program makes the computer execute setting the area being associated with each instruction in an area of the memory, and
setting a sampling value and hardware event information included in the information collected by the interrupt handler as the number of times execution has been performed in the area of the memory.

11. The computer-readable medium according to claim 7, wherein the computer program makes the computer execute:
identifying a sampling value included in the information collected by the interrupt handler with an execution form program,
comparing functions, processes, and instructions having a high execution frequency with one another,
identifying the functions, the processes, and the instructions with a corresponding C source or machine word instruction, and
displaying the functions, the processes, and the instructions on a display unit of an analysis processor connected to the computer.

12. The computer-readable medium according to claim 7, wherein the computer program makes the computer execute merging the sampling value and hardware event information included in the information collected by the interrupt handler, and
storing the merged result as an experience value in the memory.
